(19) United States
(12) Patent Application Publication
(10) Pub. No.: US 2012/0008080 A1
(43) Pub. Date: Jan. 12, 2012

(54) LIQUID CRYSTAL DISPLAY PANEL

(75) Inventor: Kazuya DAISHI, Saitama-ken (JP)

(73) Assignee: Toshiba Mobile Display Co., Ltd., Fukaya-shi (JP)

(21) Appl. No.: 13/176,999

(22) Filed: Jul. 6, 2011

(30) Foreign Application Priority Data
Jul. 8, 2010 (JP) 2010-156085

(51) Int. Cl. G02F 1/1343

(52) U.S. Cl. 349/138

(57) ABSTRACT

In one embodiment, a liquid crystal panel includes an array substrate, a counter substrate arranged opposing the array substrate through a gap between the array substrate and the counter substrate and a liquid crystal layer held between the gap. The array substrate includes a scanning line, a signal line, a switching element arranged close to an intersection of the scanning line with the signal line. A metal seat layer is formed on an insulating layer facing the signal line. A pillar-shaped spacer is formed on the metal seat layer for holding the gap between the array substrate and the counter substrate.

### CROSS-REFERENCE TO RELATED APPLICATION

This application is based upon and claims the benefit of priority from Japanese Patent Application No. 2010-156085, filed Jul. 8, 2010, the entire contents of which are incorporated herein by reference.

### FIELD

Embodiments described herein relate generally to a liquid crystal display panel.

### BACKGROUND

In recent years, a light weight, compact and high definition liquid crystal display panel is developed as a display panel. Generally, the liquid crystal display panel has an array substrate, a counter substrate facing the array substrate with a predetermined gap therebetween, and a liquid crystal layer held in the gap. The array substrate includes a glass substrate, a switching element formed on the glass substrate, an insulating layer formed on the glass substrate and the switching element, and a pixel electrode formed on the insulating layer and electrically connected with the switching element through a contact hole formed in the insulating layer.

Between two substrates, plastic beads having a uniform diameter are scattered to hold the gap between the substrates uniformly. Moreover, in case of a color display, a color filter formed of colored layers of red (R), green (G), and blue (B) is arranged on one of the array substrate and the counter substrate.

In the liquid crystal display panel constituted as mentioned-above, the plastic beads are arranged by scattering on the array substrate. Accordingly, there is a possibility that some of the plastic beads may serve as particles which pollute a production line, and the pollution may result in a generation of defective panels. Moreover, the plastic beads which are located in a pixel portion may disturb an alignment of a liquid crystal molecule, and causes a fall of display quality. Further, a poor gap is caused when the scattering density is not uniform.

As a technique of coping with the above-mentioned problem, a composition is proposed in which a plurality of pillar-shaped spacers is directly formed on the array substrate. The pillar-shaped spacer is formed on the array substrate by patterning a resin, which uses a photolithographic method, etc.

The above-mentioned pillar-shaped spacer may be formed on a pixel electrode of the array substrate. However, when the pillar-shaped spacer is formed on the pixel electrode, the region which can be used as an image display area becomes narrow in the pixel. Moreover, in a region near the pillar-shaped spacer, since the liquid crystal molecule seldom reacts, its contribution to a transmitting display decreases. In this case, the displayed image becomes dark. Furthermore, a light leaks under the influence of the alignment of the liquid crystal molecule near the pillar-shaped spacer, and the contrast ratio falls.

Then, it is possible to arrange the above-mentioned pillar-shaped spacers on other portions than the pixel electrode, that is, on an insulating layer of the array substrate to suppress deterioration of the display quality. However, in this case, an adhesion of the pillar-shaped spacer to the insulating layer is not good, and there is a possibility that the pillar-shaped spacer may be separated from the insulating layer.

### BRIEF DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 a perspective view showing a liquid crystal display panel according to one embodiment.

FIG. 2 is a plan view showing an array substrate shown in FIG. 1.

FIG. 3 is an enlarged plan view showing a portion of the array substrate shown in FIG. 1 and FIG. 2.

FIG. 4 is an equivalent circuit diagram showing a pixel of the array substrate shown in FIG. 2 and FIG. 3.

FIG. 5 is a cross-sectional view showing the liquid crystal display panel taken along line A-A of FIG. 3.

FIG. 6 is a cross-sectional view showing the liquid crystal display panel taken along line B-B of FIG. 3.

FIG. 7 is a cross-sectional view showing a modification of the above-mentioned liquid crystal display panel, and is a figure showing the modification of a pillar-shaped spacer.

### DETAILED DESCRIPTION OF THE INVENTION

A liquid crystal display panel according to an exemplary embodiment of the present invention will now be described with reference to the accompanying drawings wherein the same or like reference numerals designate the same or corresponding portions throughout the several views.

According to one embodiment, a liquid crystal display panel includes: an array substrate including; a scanning line extending in a first direction, a signal line extending in a second direction that crosses orthogonally with the first direction, a switching element arranged near an intersection area of the scanning line with the signal line, and connected to the scanning line and the signal line, a pixel electrode connected with the switching element, an insulating layer formed on the scanning line, the signal line, and the switching element, and a metal seat layer formed on the insulating layer facing the signal line, a counter substrate arranged opposing the array substrate through a gap between the array substrate and the counter substrate; a liquid crystal layer held in the gap; and a pillar-shaped spacer formed on the metal seat layer for holding the gap between the array substrate and the counter substrate.

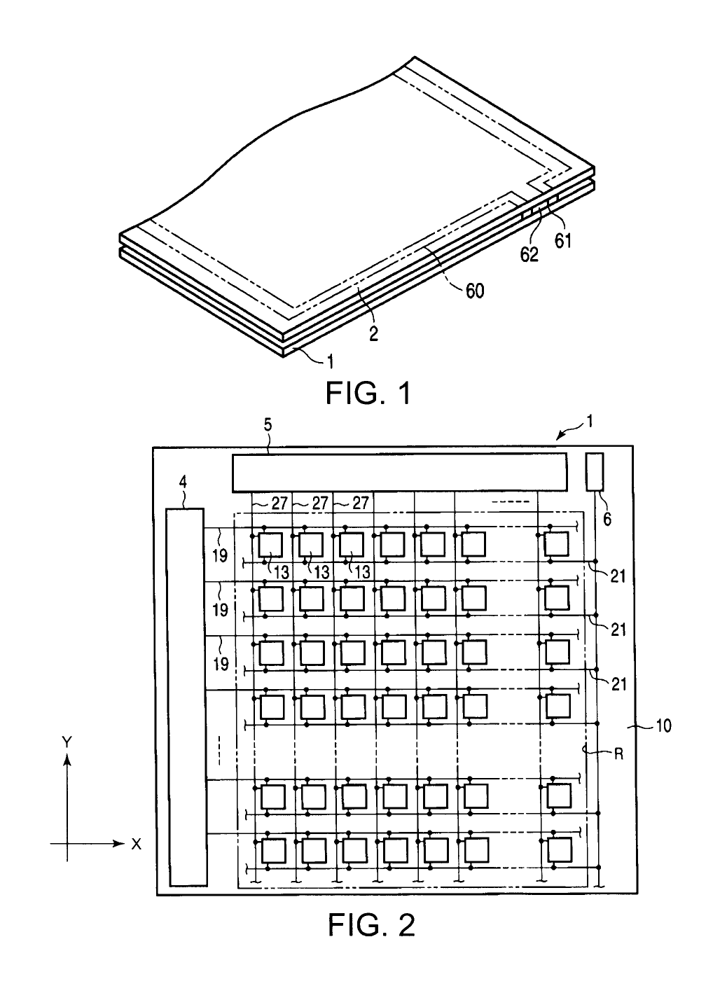

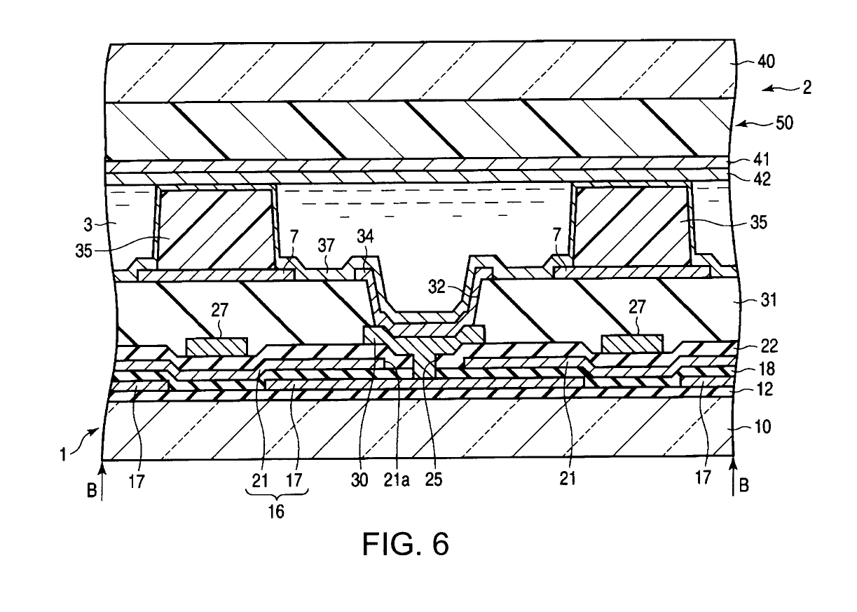

Hereafter, a liquid crystal display panel according to one embodiment is explained in detail referring to drawings. As shown in FIG. 1, FIG. 5, and FIG. 6, the liquid crystal display panel includes an array substrate 1, a counter substrate 2 opposite to the array substrate 1, and a liquid crystal layer 3 held between both substrates. The liquid crystal display panel has a display area R in which the array substrate 1 and the counter substrate 2 overlap. The array substrate 1 has a plurality of pixels 13 arranged in the shape of a matrix in the display area R. The pixel 13 is explained later.

As shown in FIG. 2, on the outside of the display area R, a scanning line driver circuit 4, a signal line driver circuit 5, and an auxiliary capacitance line driver circuit 6 are formed on the glass substrate 10. The scanning line driver circuit 4 is connected with a plurality of scanning lines 19 which are drawn to the outside of the display area R. The signal line driver circuit 5 is connected with a plurality of signal lines 27 which are drawn to the outside of the display area R. Similarly, the auxiliary capacitance line driver circuit 6 is connected with a plurality of auxiliary capacitance lines 21 which are drawn to the outside of the display area R.

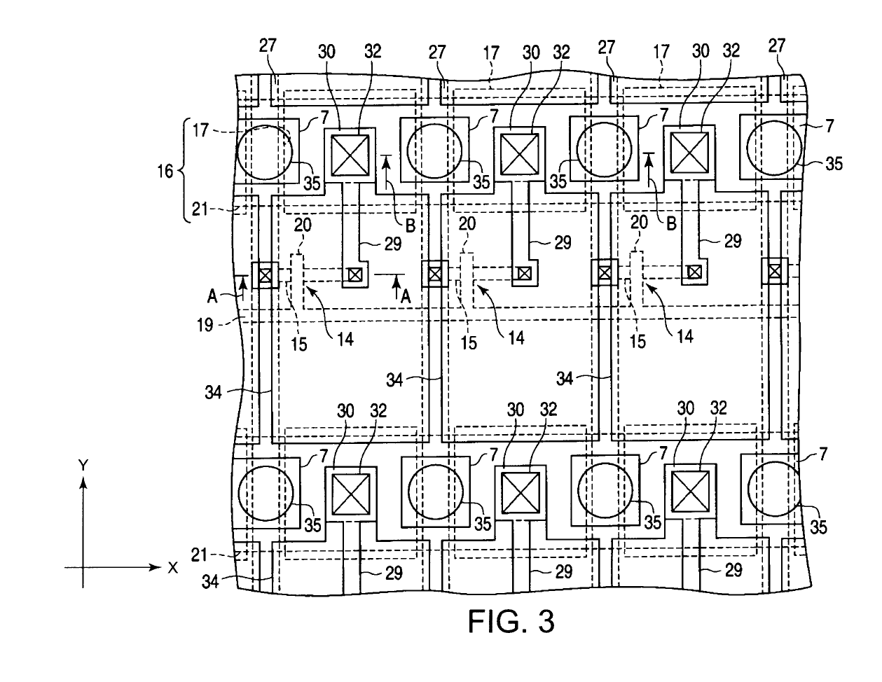

As shown in FIG. 1 to FIG. 6, the array substrate 1 is equipped with a glass substrate 10 as a transparent insulating substrate, for example. An undercoat layer 12 is formed on the glass substrate 10.

In the display area R, a plurality of scanning lines 19 extending in a first direction X and signal lines 27 extending in a second direction Y that intersects perpendicularly the first direction X are arranged on the glass substrate 10. On the glass substrate 10, a plurality of auxiliary capacitance lines 21 is also formed in parallel to the scanning line 19. In this embodiment, the auxiliary capacitance line 21 serves as a shield portion. The pixel 13 is formed in each area surrounded by adjacent two signal lines 27 and adjacent two auxiliary capacitance lines 21.

Next, the pixel 13 is explained. As shown in FIG. 2 to FIG. 6, the pixel 13 has a pixel electrode 34 and a TFT (thin film transistor) 14 as a switching element connected to the pixel electrode 34, and an auxiliary capacitance element 16.

A semiconductor layer 15 and an auxiliary capacitance electrode 17 are formed on the undercoat layer 12. The semiconductor layer 15 and the auxiliary capacitance electrode 17 are simultaneously formed with the same material by patterning a semiconductor film formed on the undercoat layer 12. In this embodiment, the semiconductor layer 15 and the auxiliary capacitance electrode 17 are formed with poly-silicon.

A gate insulating layer 18 is formed on the undercoat layer 12, the semiconductor layer 15, and the auxiliary capacitance electrode 17. A plurality of scanning lines 19, gate electrodes 20 which partially extend from the respective scanning lines 19, and auxiliary capacitance lines 21 are formed on the gate insulating layer 18. An opening 21a is formed in the auxiliary capacitance line 21 in the area which overlaps with the auxiliary capacitance electrode 17.

The scanning line 19, the gate electrode 20, and the auxiliary capacitance line 21 are simultaneously formed of a low resistance material which has a light blocking effect, such as aluminum, molybdenum tungsten, etc. In this embodiment, the scanning line 19, the gate electrode 20, and the auxiliary capacitance line 21 are formed with the molybdenum tungsten.

Each gate electrode 20 is formed so as to overlap with each semiconductor layer 15. Each auxiliary capacitance line 21 is formed so as to overlap with a plurality of auxiliary capacitance electrodes 17. The auxiliary capacitance electrode 17 and the auxiliary capacitance line 21 arranged opposing each other through the gate insulating layer 18 form an auxiliary capacitance element 16.

An interlayer insulating layer 22 is formed on the gate insulating layer 18, the scanning line 19, the gate electrode 20, and the auxiliary capacitance line 21. A plurality of source electrodes 26, signal lines 27, drain electrodes 28, connecting lines 29, and contact electrodes 30 are formed on the interlayer insulating layer 22, respectively.

The source electrode 26 and the signal line 27 are formed integrally, and are electrically connected mutually. The plurality of drain electrodes 28, connecting lines 29, and contact electrodes 30 are formed integrally, and are electrically connected mutually.

The source electrode 26 is electrically connected with a source region RS of the semiconductor layer 15 through a contact hole 23 which penetrates portions of the gate insulating layer 18 and the interlayer insulating layer 22. The drain electrode 28 is electrically connected with a drain region RD of the semiconductor layer 15 through a contact hole 24 which penetrates portions of the gate insulating layer 18 and the interlayer insulating layer 22.

Moreover, the contact electrode 30 is electrically connected with the auxiliary capacitance electrode 17 through a contact hole 25 which penetrates portions of the gate insulating layer 18 and the interlayer insulating layers 22. The contact hole 25 penetrates the opening 21a of the auxiliary capacitance line 21. For this reason, an insulating state between the contact electrode 30 and the auxiliary capacitance line 21 is maintained.

The source electrode 26, the signal line 27, the drain electrode 28, the connecting line 29, and the contact electrode 30 are simultaneously formed of a low electric resistance material which has the light blocking effect, such as aluminum, molybdenum tungsten, etc. In this embodiment, the source electrode 26, the signal line 27, the drain electrode 28, the connecting line 29, and the contact electrode 30 are formed with aluminum.

A planarization film 31 is formed with transparent resin as an insulating layer on the interlayer insulating layer 22, the source electrode 26, the signal line 27, the drain electrode 28, the connecting line 29, and the contact electrode 30. In this embodiment, the planarization film 31 is formed of an organic insulating layer. The planarization film 31 has a plurality of contact holes 32 formed in overlapping with the auxiliary capacitance line 21 and the contact electrode 30, respectively.

On the planarization film 31, the plurality of pixel electrodes 34 are formed of transparent electric conductive materials, such as ITO (Indium Tin Oxide). The pixel electrodes 34 are arranged in the shape of a matrix. The pixel electrode 34 is electrically connected with the contact electrode 30 through the contact hole 32. The pixel electrode 34 is formed so that the peripheral edge of the pixel electrode 34 is overlapped with adjacent two signal lines 27 and adjacent two auxiliary capacitance lines 21. The pixel electrode 34 has a long axis in the direction along the signal line 27.

Moreover, on the planarization film 31, a plurality of metal seat layers 7 are formed. The metal seat layer 7 is simultaneously formed using the same material as the pixel electrode 34. In this embodiment, the metal seat layer 7 is formed in the shape of a rectangle, and is arranged apart from the pixel electrode 34. Moreover, the metal seat layer 7 is arranged on an intersection portion of the auxiliary capacitance line 21 with the signal line 27.

When forming the above-mentioned pixel electrode 34 and the metal seat layer 7, after forming the planarization film 31, ITO is deposited on the whole surface of the glass substrate 10 (or mother glass before dividing the glass substrate 10), for example, by a sputtering method, and thereby an electric conductive film is formed. Then, the plurality of pixel electrodes 34 and the metal seat layers 7 can be formed by patterning the electric conductive film.

On the plurality of metal seat layers 7, the plurality of pillar-shaped spacers 35 are formed, respectively. The pillar-shaped spacers 35 hold the gap between the array substrate 1 and the counter substrate 2. The pillar-shaped spacer 35 is formed on the metal seat layer 7 so as to overlap and stay on the metal seat layer 7. Off course, the pillar-shaped spacer 35 is formed apart from the contact hole 32.

When forming the above-mentioned pillar-shaped spacer 35, first, an ultraviolet curing type acrylic resin is dropped as a resist on the glass substrate 10 (or above-mentioned mother glass) in which the pixel electrode 34 and the metal seat layer 7 are formed, and an acrylic resin is applied on whole surface of the glass substrate 10 with a spin coat method performed by rotating the glass substrate 10.

Then, after pre-backing the glass substrate 10 in which the acrylic resin is applied, the glass substrate 10 is exposed using a predetermined photo-mask. Thereby, a portion of the acrylic resin to be left is hardened. The photo-mask used for the exposure has a pattern for forming the pillar-shaped spacer 35.

Then, the acrylic resin is developed in a solution of TMAH (tetra-methyl ammonium hydride), and is washed in cold water to remove an unnecessary acrylic resin. Then, post-baking of the acrylic resin is carried out. As mentioned-above, a plurality of pillar-shaped spacers 35 can be formed by patterning the acrylic resin using the photolithographic method.

An alignment film 37 is formed on the planarization film 31, the pixel electrode 34, the metal seat layer 7, and the pillar-shaped spacer 35. Each of the pixels 13 has a TFT 14, an auxiliary capacitance element 16, and an pixel electrode 34, respectively.

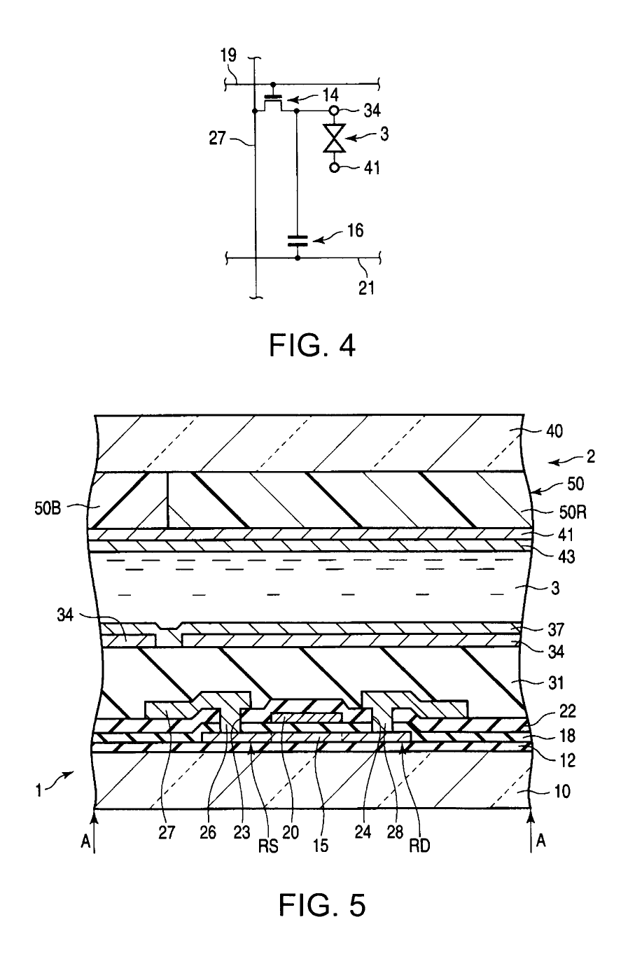

Next, the counter substrate 2 is explained. As shown in FIG. 1, FIG. 4, FIG. 5, and FIG. 6, the counter substrate 2 includes a glass substrate 40 as a transparent insulating substrate, for example. A color filter 50 is formed on the glass substrate 40.

Although not illustrated, the color filter 50 has colored layers, such as red, blue and green colored layers. Each colored layer is formed in a stripe shape and arranged in parallel to the direction to which the signal line 27 extends. The periphery of each colored layer overlaps with the signal line 27. A counter electrode 41 is formed of transparent electric conductive material, such as ITO on the color filter 50. An alignment film 43 is formed on the color filter 50 and the counter electrode 41.

The array substrate 1 and the counter substrate 2 are arranged opposing each other and hold the predetermined gap therebetween by the plurality of pillar-shaped spacers 35. The array substrate 1 and the counter substrate 2 are attached by a seal material 60 arranged between both substrates in the peripheral region of the display area R. The liquid crystal layer 3 is formed in an area surrounded by the array substrate 1, the counter substrate 2, and the seal material 60. A liquid crystal injecting mouth 61 is formed in a portion of the seal material 60, and the liquid crystal injecting mouth is sealed with a sealing agent 62.

According to the liquid crystal display panel constituted as mentioned-above, the pixel electrode 34 and the metal seat layer 7 using the same material as the pixel electrode 34 are formed on the planarization film 31 which is an insulating layer. The pillar-shaped spacer 35 is formed on the metal seat layer 7.

The metal seat layer 7 is excellent in adhesion to the pillar-shaped spacer 35 compared with the planarization film 31. Since the metal seat layer 7 can suppress the peeling off of the pillar-shaped spacer 35, the pillar-shaped spacer 35 can be formed in a reliable condition.

Moreover, since the pillar-shaped spacer 35 is arranged apart from the pixel electrode 34 (optical transmitting area), the fall of the luminous level of the displayed image and the fall of a contrast ratio are prevented, respectively. In addition, since the metal seat layer 7 is arranged apart from the pixel electrode 34, an alignment disorder of the liquid crystal molecule near the pixel electrode 34 can be suppressed, and further the deterioration of the display quality can be suppressed. As described-above, the liquid crystal display panel can be provided, in which the deterioration of display quality can be controlled, and a high manufacturing yield can be obtained.

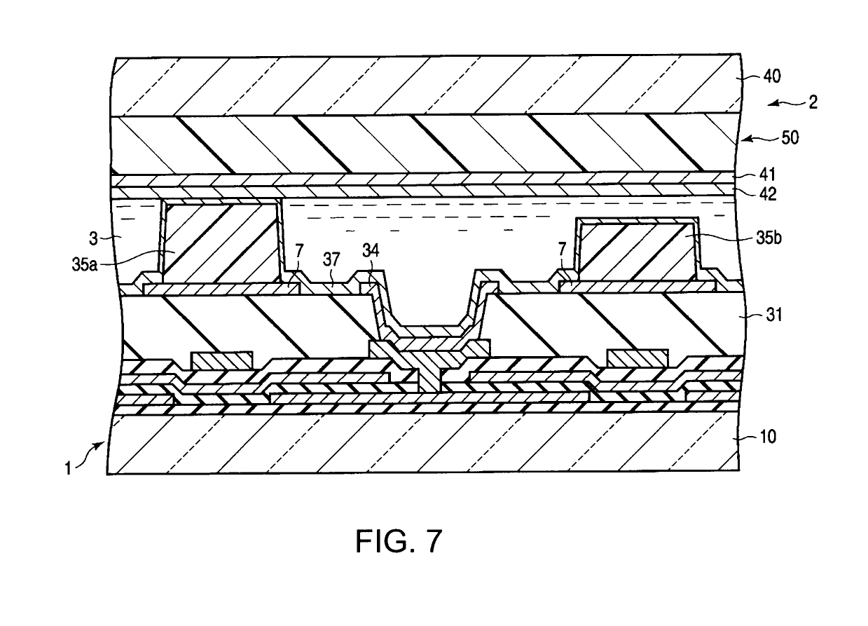

For example, the pillar-shaped spacers are not limited to the pillar-shaped spacers 35 as mentioned-above, and can change variously. For example, as shown in FIG. 7, either one of a first pillar-shaped spacer 35a and a second pillar-shaped spacer 35b which is formed lower than the first pillar-shaped spacer 35a may be used. That is, a clearance is formed between the second pillar-shaped spacer 35b and the counter substrate 2. In this case, the first pillar-shaped spacer 35a and the second pillar-shaped spacer 35b can be simultaneously formed using the same material by a photo-mask with several patterns in which the transmissivity of ultraviolet-ray differs mutually is used.

In this case, it was confirmed that an adhesion of the second pillar-shaped spacer 35b to the metal seat layer 7 is worsened compare with the first pillar-shaped spacer 35a due to fewer amount of ultraviolet exposures in an experiment. It became clear that adhesion was improved compared with the case where the second pillar-shaped spacer 35b is formed on the organic insulating layer 31 by forming the second pillar-shaped spacer 35b on the metal seat layer 7 of the same material as the pixel electrode 34. Accordingly, it becomes possible to prevent a peeling off of the second pillar-shaped spacer 35b by forming the second pillar-shaped spacer 35b on the metal seat layer 7 of the same material as the pixel electrode 34.

The first pillar-shaped spacer 35a always holds the gap between the array substrate 1 and the counter substrate 2. The second pillar-shaped spacer 35b holds the gap between the array substrate 1 and the counter substrate 2 when the liquid crystal material contracts, or when a pressure is applied to the liquid crystal display panel.

The pillar-shaped spacer 35, the first pillar-shaped spacer 35a and the second pillar-shaped spacer 35b may partially overlap with the metal seat layer 7, and a portion of the pillar-shaped spacers may be out of the metal seat layer 7. The metal seat layer 7 may be integrally formed with the pixel electrode 34. The material used for the pixel electrode 34 and the metal seat layer 7 may be a metal including a transparent electric conductive material without limiting to ITO. For example, the material used for the pixel electrode 34 and the metal seat layer 7 may be IZO (Indium Zinc Oxide).

While certain embodiments have been described, these embodiments have been presented by way of example only, and are not intended to limit the scope of the inventions. In practice, the structural and method elements can be modified without departing from the spirit of the invention. Various embodiments can be made by properly combining the structural and method elements disclosed in the embodiments. For example, some structural and method elements may be omitted from all the structural and method elements disclosed in the embodiments. Furthermore, the structural and method elements in different embodiments may properly be combined. The accompanying claims and their equivalents are intended to cover such forms or modifications as would fall with the scope and spirit of the inventions.

What is claimed is:

1. A liquid crystal display panel, comprising:
an array substrate including;
a scanning line extending in a first direction,
a signal line extending in a second direction that crosses orthogonally with the first direction,
a switching element arranged near an intersection area of the scanning line with the signal line, and connected to the scanning line and the signal line,
a pixel electrode connected with the switching element,
an insulating layer formed on the scanning line, the signal line, and the switching element, and
a metal seat layer formed on the insulating layer facing the signal line,
a counter substrate arranged opposing the array substrate through a gap between the array substrate and the counter substrate;
a liquid crystal layer held in the gap; and
a pillar-shaped spacer formed on the metal seat layer for holding the gap between the array substrate and the counter substrate.

2. The liquid crystal display panel according to claim 1, wherein the metal seat layer is arranged apart from the pixel electrode.

3. The liquid crystal display panel according to claim 1, wherein the insulating layer is formed of an organic insulating layer.

4. The liquid crystal display panel according to claim 1, further comprising an auxiliary capacitance line formed on the array substrate in parallel to the scanning line, wherein the metal seat layer is formed at an intersection area of the auxiliary capacitance line with the signal line.

5. The liquid crystal display panel according to claim 1, wherein the metal seat layer is formed of the same material as the pixel electrode.

6. The liquid crystal display panel according to claim 5, wherein the metal seat layer and the pixel electrode are formed of ITO (Indium Tin Oxide) or IZO (Indium Zinc Oxide).

7. The liquid crystal display panel according to claim 6, wherein the metal seat layer is integrally formed with the pixel electrode.

8. A liquid crystal display panel, comprising:
an array substrate including;
a scanning line extending in a first direction,
a signal line extending in a second direction that crosses orthogonally with the first direction,
a switching element arranged near an intersection area of the scanning line with the signal line, and connected to the scanning line and the signal line,
a pixel electrode connected with the switching element,
an insulating layer formed on the scanning line, the signal line, and the switching element, and
a first and second metal seat layers formed on the insulating layer facing the signal line, respectively;
a counter substrate arranged opposing the array substrate through a gap between the array substrate and the counter substrate;
a liquid crystal layer held in the gap;
a first pillar-shaped spacer formed on the first metal seat layer for holding the gap between the array substrate and the counter substrate; and
a second pillar-shaped spacer formed on the second metal seat layer, wherein a clearance is formed between the second pillar-shaped spacer and the counter substrate.

9. The liquid crystal display panel according to claim 8, wherein the metal seat layer is arranged apart from the pixel electrode.

10. The liquid crystal display panel according to claim 8, wherein the insulating layer is formed of an organic insulating layer.

11. The liquid crystal display panel according to claim 8, further comprising an auxiliary capacitance line formed on the array substrate in parallel to the scanning line, wherein the metal seat layer is formed at an intersection area of the auxiliary capacitance line with the signal line.

12. The liquid crystal display panel according to claim 8, wherein the metal seat layer is formed of the same material as the pixel electrode.

13. The liquid crystal display panel according to claim 12, wherein the metal seat layer is integrally formed with the pixel electrode.

14. A liquid crystal display panel, comprising:
an array substrate including;
a pair of scanning lines extending in a first direction,
a pair of signal lines extending in a second direction that crosses orthogonally with the first direction,
a pair of auxiliary capacitance lines in parallel to the scanning lines,
a switching element arranged near an intersection area of the scanning line with the signal line, and connected to the scanning line and the signal line,
an insulating layer formed on the scanning line, the signal line, and the switching element,
a pixel electrode connected to the switching element and formed in a surrounded region by the pair of scanning lines and signal lines, the pixel electrode being connected to the auxiliary capacitance line through a contact hole formed in the insulating layer,
a pair of first and second metal seat layers formed on the insulating layer facing the signal line,
a counter substrate arranged opposing the array substrate through a gap between the array substrate and the counter substrate;
a liquid crystal layer held in the gap; and
a first and second pillar-shaped spacers formed on the pair of first and second metal seat layers, respectively;
wherein the first and second pillar-shaped spacers are formed at a cross portion of the auxiliary capacitance line with the signal line.

15. The liquid crystal display panel according to claim 14, wherein
the first pillar-shaped spacer is formed on the first metal seat layer for holding the gap between the array substrate and the counter substrate; and
the second pillar-shaped spacer is formed on the second metal seat layer, wherein a clearance is formed between the second pillar-shaped spacer and the counter substrate.

16. The liquid crystal display panel according to claim 14, wherein the insulating layer is formed of an organic insulating layer.

17. The liquid crystal display panel according to claim 14, wherein the metal seat layer is formed of the same material as the pixel electrode.

18. The liquid crystal display panel according to claim 17, wherein the metal seat layer and the pixel electrode are formed of ITO (Indium Tin Oxide) or IZO (Indium Zinc Oxide).

19. The liquid crystal display panel according to claim 18, wherein the seat layer is integrally formed with the pixel electrode.

20. The liquid crystal display panel according to claim 14, wherein the first and second pillar-shaped spacers are arranged on the first and second metal seat layers so as to partially overlap with the first and second metal seat layers, respectively.
